(19) United States
(12) Patent Application Publication
(10) Pub. No.: US 2016/0363181 A1
(43) Pub. Date: Dec. 15, 2016

(54) CONSTRICTING DRUM BRAKE ASSEMBLY

(71) Applicant: Eaton Corporation, Cleveland, OH (US)

(72) Inventors: Edward Lee Luehring, Lakewood, OH (US); Thaveesak Boonpongmanee, Westlake, OH (US)

(21) Appl. No.: 15/168,570

(22) Filed: May 31, 2016

Related U.S. Application Data
(60) Provisional application No. 62/175,522, filed on Jun. 15, 2015.

(51) Int. Cl. F16D 49/18; F16D 65/06; F16D 65/22; F16D 67/04; F16D 13/10; F16D 13/62; F16D 13/72; F16D 25/04; F16D 65/12; F16D 65/807

(52) U.S. Cl. CPC F16D 49/18; F16D 65/12; F16D 65/06; F16D 65/22; F16D 65/807; F16D 13/10; F16D 13/62; F16D 13/72; F16D 25/046; F16D 67/04; F16D 2125/14

(57) ABSTRACT

An improved constricting drum brake assembly 10 having friction elements 32 removably attached to an outer reaction surface 40 about the periphery of a cylindrical drum 26 a plurality of ventilated shoes 28 situated within a coupling component 12 and constructed to engage the friction elements 32 upon inflation of an expandable flexible tube 30 transfers heat from the drum generated during braking action.

### BACKGROUND

The present disclosure relates in general to a constricting drum brake assembly, and more particularly to a constricting drum brake assembly with ventilated shoes and friction elements disposed on a drum useful for a wide variety of industrial or commercial applications requiring braking action.

Constricting brake assemblies are used to transmit power in a controlled manner between two members. In many applications, the constricting brake assembly is used both for the function of transmitting movement from a driving to a driven member as well as to stop or slow the rotation of a driving or driven member when desired. Constricting brake assemblies are used in high power, high torque applications like grinding mills, marine propulsion, metal forming machinery, or oil field machinery.

In a constricting pneumatic drum brake, an inflatable tube in a brake housing is employed and expanded with a fluid at selected times for braking action or in other applications as a clutch. As used herein the term “constricting drum brake assembly” or “pneumatic constricting brake assembly” or “constricting brake assembly” or the like is intended to encompass a brake assembly that can function either as a brake, a clutch, or both through a braking action. The inflatable tube acts upon friction elements positioned within the coupling component causing them to engage against the outer surface of a drum for the braking action. Heat is generated during the braking action and this heat needs to be dissipated in an efficient manner.

The energy absorbed by the drum during the braking action can also result in high thermal stresses that in turn can crack the cylindrical drum. Cracked drums in turn can cause accelerated wear of the friction elements and potential for further failure, including fragmenting of the drum that can result in hazards to personnel and damage to associated machinery.

Thus, there still exists a need for an improved constricting drum brake assembly which dissipates heat generated during the braking action to reduce the surface temperature of the drum and surrounding areas, and extend the life of the drum.

### SUMMARY

The present disclosure describes an improved constricting drum brake assembly having at least one coupling component with a plurality of ventilated shoes operably disposed therein for radial movement. A cylindrical drum is disposed for rotary movement within the coupling component. The drum has an annular outer reaction surface with a plurality of friction elements removably mounted thereon and situated to engage the ventilated shoes in the coupling component. An inflatable tube within the at least one coupling component upon inflation moves the plurality of ventilated shoes into an engaging contact with the plurality of friction elements on the outer reaction surface of the cylindrical drum for a braking action.

The present disclosure also relates to an improved drum for a constricting drum brake assembly. The cylindrical drum is constructed to be located within at least one coupling component for rotary movement. The cylindrical drum has an annular outer reaction surface about a periphery of the cylindrical drum with a plurality of friction elements removably attached thereto. The plurality of friction elements attached to the cylindrical drum are situated in an arrangement corresponding to an arrangement of a plurality of ventilated shoes within the coupling component for engagement to effect the braking action.

### BRIEF DESCRIPTION OF THE DRAWINGS

FIG. 1 is a perspective view of an example of a constricting drum brake assembly according to the present disclosure;

FIG. 2 is a side plan view of the coupling component of the constricting drum brake assembly shown in FIG. 1;

FIG. 3 is a partial sectional view of the improved constricting drum brake assembly according to the present disclosure;

FIG. 4 is perspective view with a section removed of an example of a coupling component of the constricting drum brake assembly according to an embodiment of the present disclosure;

FIG. 5 is a sectional view of an illustration depicting the improved constricting drum assembly 10 according to an embodiment of the present disclosure;

FIG. 6 is an elevated perspective view of a drum with friction elements according to an embodiment of the present disclosure;

FIG. 7 is a perspective view of one of the ventilated shoes according to one embodiment of the present disclosure;

FIG. 8 is a perspective view of one of the ventilated shoes according to another embodiment of the present disclosure; and

FIG. 9 is a sectional illustration of the improved constricting drum brake assembly according to an embodiment of the present disclosure.

### DETAILED DESCRIPTION

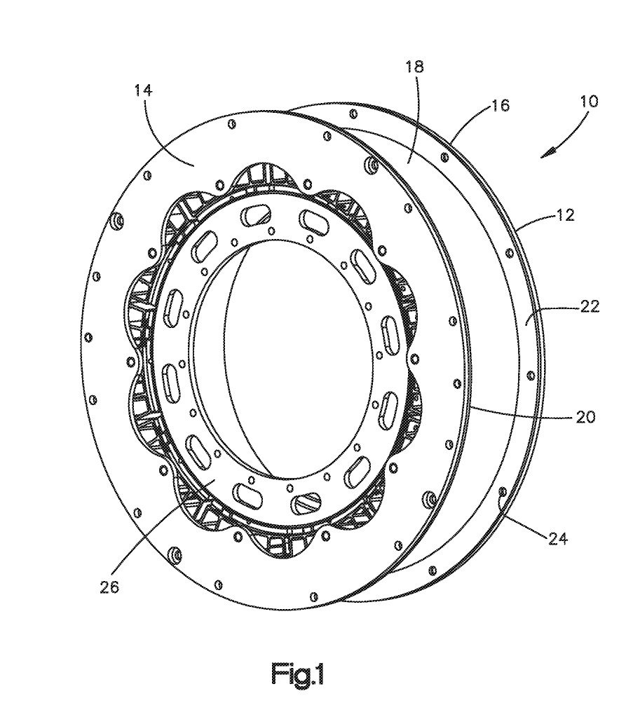

Referring now to the drawings, which are not intended to limit the subject disclosure and where like numerals designate like or similar features throughout the several views, FIG. 1 depicts an example of a constricting drum brake assembly generally designated 10 that has the ability to function either as a clutch or as a brake. The brake assembly 10 has a generally annular coupling component 12 that may include a pair of scalloped metal annular side plates 14 and 16. A metal rim 18 extends transversely between the side plates 14, 16. Rim 18 may include flange portions 20 and 22 which are attachable to an adjacent side plate by fasteners (not shown) through openings 24. In other embodiments, there may be more than one coupling component 12 provided disposed adjacent to each other and may be attached through openings 24.

Brake assembly 10 includes a central generally cylindrical metal drum 26. The annular drum 26 is rotatably movable relative to the coupling component 12 when the brake assembly 10 is disengaged. When the brake assembly 10 is engaged, the drum 26 becomes operatively connected with the coupling component 12 in a manner later discussed in far greater detail. As a result the drum 26 is in an operative condition with a driving member (not shown) and the coupling component 12 is in operative connection with a driven member (not shown). Rotating motion of the driving member can be selectively applied to the driven member by engaging and disengaging the brake assembly 10, or by controlling the engaging force applied through the coupling component 12 to the drum 26.

The coupling component 12 according to the present disclosure includes a plurality of curved ventilated shoes 28 that are selectively radially movable with the inflation and expansion of an annular flexible and expandable tube 30 through fluid pressure, like air, applied through one or more fluid conduits 34. The operative engagement of the coupling component 12 with the drum 26 is achieved by the movement of the plurality of ventilated shoes 28 engaging friction elements 32 attached to drum 26 as will be described in far greater detail later herein. The annular inflatable tube 30 surrounds the annular array of ventilated shoes 28 disposed within coupling component 12. Upon inflation of tube 30, the ventilated shoes 28 move radially inward so as to operatively engage the coupling component 12 with the friction elements 32 on drum 26. The ventilated shoes 28 are enabled to be selectively movable radially outward upon release of the fluid pressure in tube 30 so as to operatively disengage the coupling component 12 from the drum 26. The constricting drum brake assembly 10 can function in a controllable manner through the inflation and deflation of the expandable tube 30 to engage and disengage the drum 26.

When fluid pressure, normally air, is released from the interior of the tube 30, the tube 30 is reduced in radial size and release springs 36 cause the ventilated shoes 28 to move radially outward. This disengages the coupling component 12 from the drum 26, and enables relative movement of the coupling component 12 and the drum 26 until elevated fluid pressure is again applied to the expandable tube 30. As can be appreciated, the radially inward directed force applied to the friction elements 32, which may be blocks or linings, on drum 26 can be controlled by regulating the fluid pressure applied to the expandable tube 30. Flow control valves (not shown) for controlling the rate of fluid flow to and/or from the expandable tube 30 may be included in the delivery passage that connects to the one or more fluid conduits 34.

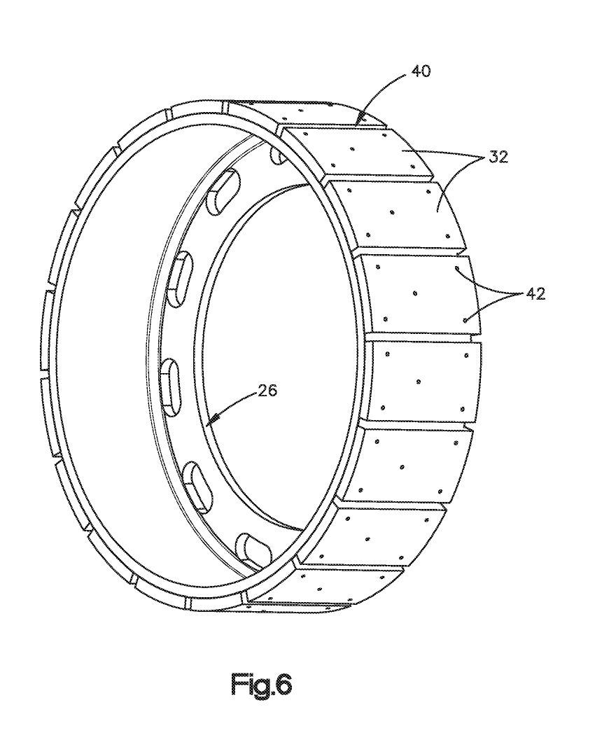

As best seen in FIG. 6, the friction elements 32 are attached to the outer reaction surface 40 of the drum 26 with fasteners 42 such as rivets, screws, threaded fasteners, or other suitable means, or alternatively through bonding friction linings on the drum. The friction elements 32 are removably attached to the drum to allow for replacement due to wear. The replacement of the friction elements 32 from the drum 26 is faster and easier than replacing friction elements contained within the coupling component. Friction elements 32 may be blocks of friction material composed of sintered metal material such as a composite of primarily sintered iron. This material offers a high strength friction pad. The friction blocks may be comprised of ceramic materials, carbon fiber materials, non-asbestos organic materials, or other materials that are suitable for high pressure, shear, wear, and heat conditions that are encountered in the operation of constricting drum brake applications used in industrial type operations like in canning, mining, and oil drilling businesses.

The friction blocks 32 may be arranged in a selective staggered manner in an orientation or array around an outer periphery on the outer reaction surface 40 of drum 26 in a manner that positions each friction block 32 substantially below a corresponding curved ventilated shoe 28 in the coupling component 12 contoured to the shape of the friction block. This corresponding relationship between each ventilated shoe 28 and each friction block 32 may improve the torque of the drum brake assembly 10. The width of the outer reaction surface 40 of the cylindrical drum 26 and number of curved friction elements 32 may be sized to accommodate the number of coupling components 12 to be employed. For example, if two coupling components 12 are employed, the outer reaction surface 40 of the drum 26 may be wider to accommodate the two coupling components. Similarly, the friction elements 32 on the drum may be enlarged to correspond to the ventilated shoes 28 on both coupling components 12, or alternatively, the friction blocks 32 may be mounted side by side adjacent to each other to cover any increase in the width of the outer reaction surface 40 of drum 26, and to correspondingly be sized to engage the ventilated shoes 28 from each of the coupling components 12.

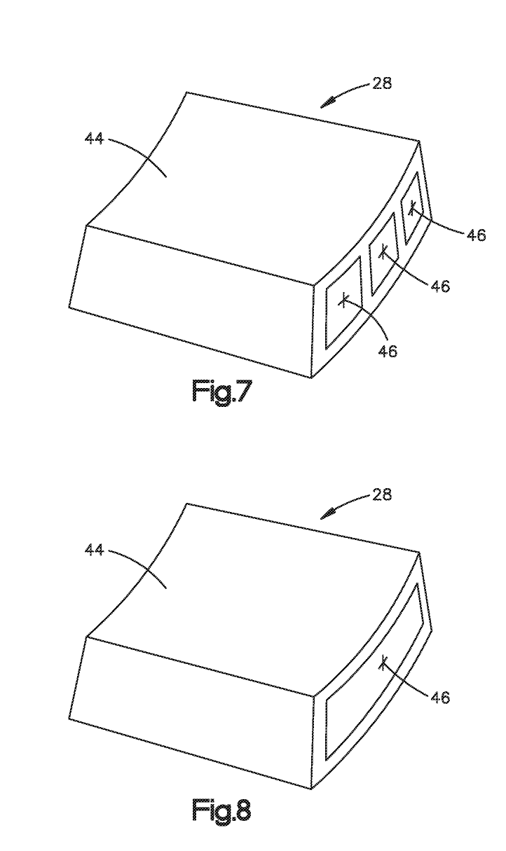

Turning now to FIG. 7, there is depicted a side view of one of the ventilated shoes 28 contained within the coupling component 12. The ventilated shoes are made of a thermally conductive and wear resistant material metallic material or a metal matrix composite (MMC) that may be reinforced like an aluminum metal matrix composite, aluminum alloy metal matrix composite, SiC aluminum metal matrix composite, aluminum graphite metal matrix composite, or other metal matrix composite offering excellent thermal conductivity and wear resistance. The metal matrix composite offers a high thermal conductivity greater than that of a nickel-iron alloy, and is greater than approximately 17 Watts per meter Kelvin, W/(m-K). Ventilated shoe 28 may be composed entirely of the metal matrix composite, or alternatively the surface on one side 44 of the ventilated shoe 28 which contacts and engages the friction element 32 on the outer surface 40 of drum 26 may be made of the metal matrix composite while the remainder of the shoe 28 is made of a light weight metal like aluminum or titanium. In another embodiment, the contact side 44 may consist of a thermally conductive and wear resistant metal plate fastened to the ventilated shoe 28 with fasteners, bonding, or molded in place. The shoes 28 are curved and configured to correspond to the curvature of the friction elements 32. Shoes 28 in one embodiment have a ventilated profile or structure with several passages 46 through their entire length to dissipate heat that is generated during the engagement with the friction elements 32 during the braking action. As seen in the embodiment in FIG. 7, there are three fairly large passages 46 that can allow cooling air to flow through the passages. This construction coupled with the scalloped side plates 14 and 16 allow cooling air to flow through.

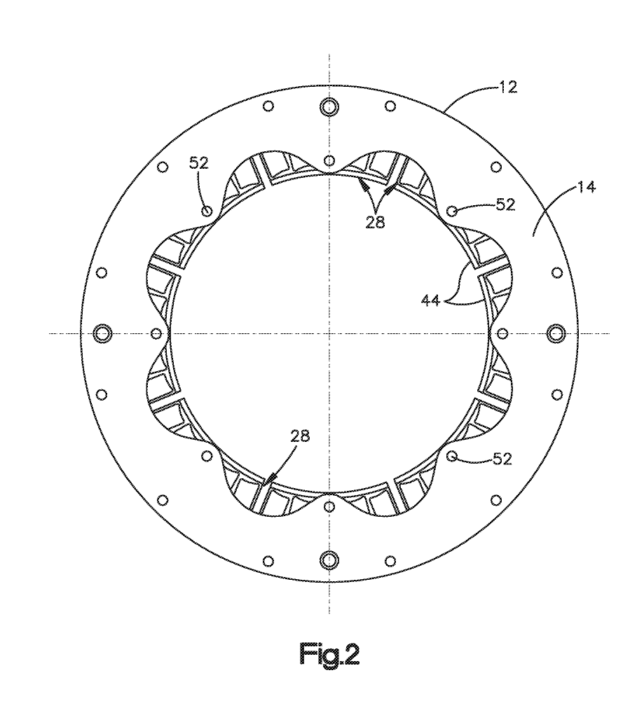

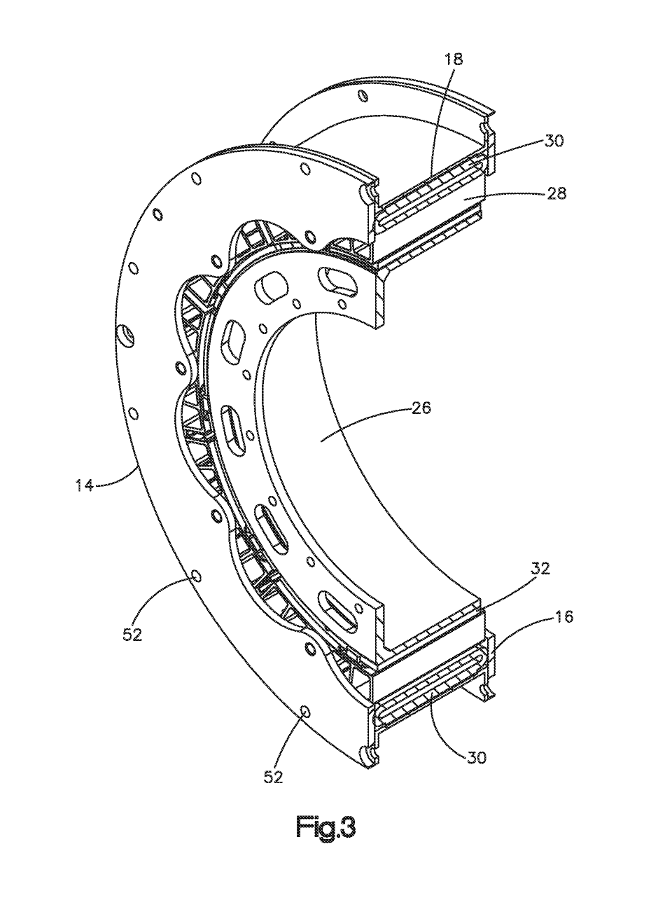

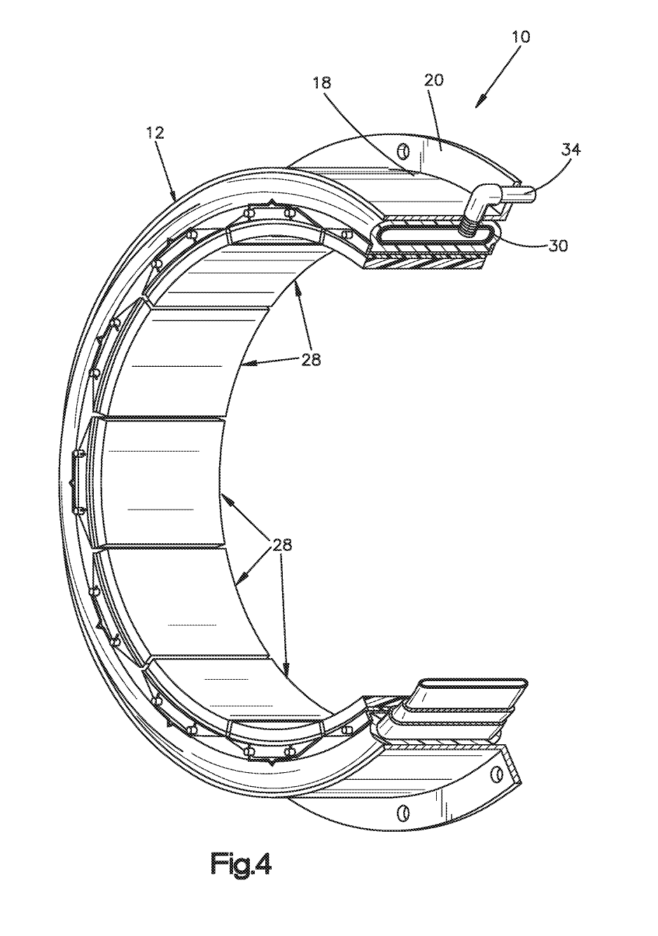

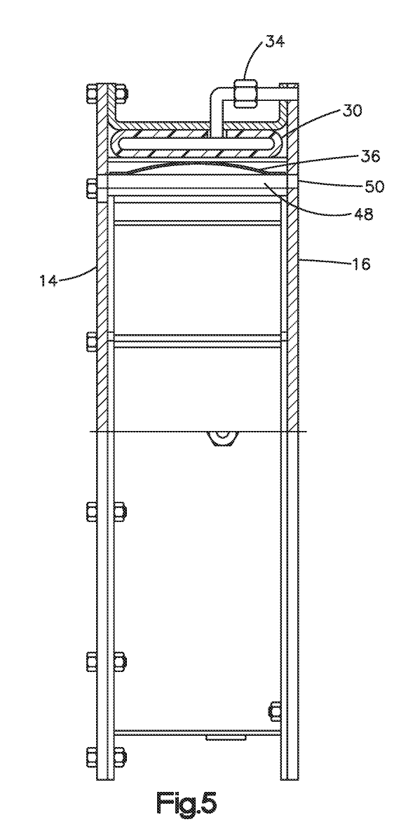

As depicted in FIGS. 2 and 5, the ventilated shoes 28 are mounted between the two substantially parallel metal side plates 14 and 16 of the coupling component 12. At least one rigid rectangularly shaped metal bar 48 with cylindrical shaped ends 50 passes through the fairly centrally located passage 46 of each shoe 28. The round ends 50 of the bar 48 are firmly retained into corresponding holes 52 in the side plates 14 and 16. A metal release leaf spring 36 positioned in each shoe 28 on the bar 48 assists in retracting each shoe 28 away from the drum 26 when the fluid pressure in tube 30 is exhausted from the tube.

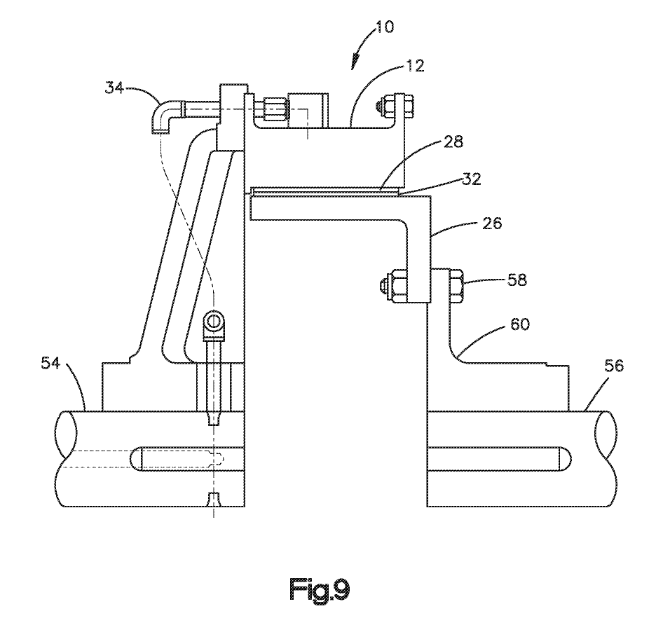

FIG. 9 shows in illustrated form an embodiment of the present disclosure functioning as a clutch by connecting a driving member 54 to a driven member 56. The coupling component 12 which is connected to the driving member 54 receives fluid pressure through fluid conduit 34 which upon inflation of expandable tube 30 within the coupling component 12 causes the ventilated shoes 28 to engage the friction elements 32 on drum 26. Drum 26 is attached by way of fasteners 58 to a hub 60 which is connected to the driven member 56.

The exemplary embodiments have been described with reference to the present disclosure. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

I claim:

1. An improved constricting drum brake assembly, comprising:
(a) a coupling component having a plurality of ventilated shoes operably disposed therein for radial movement;
(b) a cylindrical drum disposed for rotary movement with respect to the coupling component, the drum having an annular outer reaction surface having a plurality of friction elements removably mounted thereon and situated to engage the ventilated shoes; and
(c) an inflatable tube disposed within the coupling component operable upon inflation to move the plurality of ventilated shoes into an engaging contact with the plurality of friction elements on the outer reaction surface of the cylindrical drum for a braking action.

2. The constricting drum brake assembly as defined in claim 1, wherein each of the plurality of ventilated shoes include a metallic surface on a side of the ventilated shoe constructed to engage one of the plurality of friction elements.

3. The constricting drum brake assembly as defined in claim 2, wherein the metallic surface comprises a metal matrix material.

4. The constricting drum brake assembly as defined in claim 1, wherein each of the plurality of ventilated shoes are manufactured from a metal matrix material.

5. The constricting drum brake assembly as defined in claim 4, wherein the metal matrix has a thermal conductivity greater than approximately 17 W/(m-K).

6. The constricting drum brake assembly as defined in claim 2, wherein the metallic surface on the ventilated shoe comprises a metal plate attached to the ventilated shoe.

7. The constricting drum brake assembly as defined in claim 1, wherein the plurality of friction elements are removably attached to the cylindrical drum with fasteners.

8. The constricting drum brake assembly as defined in claim 1, wherein the plurality of friction elements are removably attached to the cylindrical drum through bonding.

9. The constricting drum brake assembly as defined in claim 7, wherein the friction elements comprise friction blocks.

10. The constricting drum brake assembly as defined in claim 8, wherein the friction elements comprise friction blocks.

11. An improved drum for a constricting drum brake assembly, comprising:
(a) a cylindrical drum constructed to be disposed for rotary movement within a coupling component, the cylindrical drum having an annular outer reaction surface about a periphery of the cylindrical drum; and
(b) a plurality of friction elements removably mounted on the annular outer reaction surface of the cylindrical drum in an arrangement corresponding to an arrangement of a plurality of ventilated shoes within the coupling component for engagement to effect the braking action.

12. An improved drum as defined in claim 11, wherein the plurality of friction elements comprise friction blocks.

13. An improved drum as defined in claim 12, wherein the plurality of friction blocks are removably attached to the outer reaction surface about the periphery of the cylindrical drum with fasteners.

14. An improved drum as defined in claim 12, wherein the plurality of friction blocks are removably attached to the outer reaction surface about the periphery of the cylindrical drum through bonding.
